(19) United States
(12) Patent Application Publication
(10) Pub. No.: US 2014/0288803 A1
(43) Pub. Date: Sep. 25, 2014

(54) Vehicle With Engine Start-Stop Device and Method of Operating Same

(71) Applicant: Bayerische Motoren Werke Aktiengesellschaft, Muenchen (DE)

(72) Inventor: Christopher DEISLER, Muenchen (DE)

(21) Appl. No.: 14/299,819

(22) Filed: Jun. 9, 2014

Related U.S. Application Data
(63) Continuation of application No. PCT/EP2012/072017, filed on Nov. 7, 2012.

(30) Foreign Application Priority Data
Dec. 9, 2011 (DE) 10 2011 088 188.3

(51) Int. Cl. F02N 11/08

(52) U.S. Cl. CPC F02N 11/0825
USPC 701/103

(57) ABSTRACT

A vehicle having an internal combustion engine can be switched off automatic and can be started automatically by way of an engine start/stop device. The vehicle includes at least one electric energy store and at least one electric consumer. In the case of an internal combustion engine which has been switched off automatically, a stop current strength which is removed from the at least one electric energy store by the at least ne electric consumer can be determined. The engine start/stop device automatically starts the internal combustion engine if a predefined stop current threshold or a predefined stop discharge threshold is exceeded.

### CROSS REFERENCE TO RELATED APPLICATIONS

This application is a continuation of PCT International Application No. PCT/EP2012/072017 filed Nov. 7, 2012, which claims priority under 35 U.S.C. §119 from German Patent Application No. 10 2011 088 188.3, filed Dec. 9, 2011, the entire disclosures of which are herein expressly incorporated by reference.

### BACKGROUND AND SUMMARY OF THE INVENTION

The invention relates a vehicle having an internal-combustion engine which can be automatically switched off and automatically started by way of an engine start-stop device.

For saving fuel in internal-combustion-engine vehicles, automatic engine start-stop systems are used according to the state of the art. If during the vehicle operation, the vehicle is brought to a stop—for example, at a red traffic light or at a railroad crossing—the internal-combustion engine can automatically be switched off, while maintaining defined marginal conditions, by suppressing the fuel supply during the stationary phase. A marginal condition is, for example, created by the engine temperature. According to DE 44 12 438 C1, the engine is switched off only when the engine temperature falls below a specified temperature.

As soon as the stationary phase has ended and the drive is to be continued, which the driver usually indicates by touching the clutch pedal in the case of a vehicle with a manual transmission, or by touching the accelerator pedal in the case of a vehicle with an automated transmission, the engine start-stop system will start the internal-combustion engine by way of the starter rotating the engine and the starting of the fuel injection (including the ignition in the case of a gasoline engine).

Also during the vehicle stoppage, i.e. when the stationary phase has not yet ended, the engine can be switched on, as required, by the engine start-stop system. According to DE 44 12 438 C1, this is so, for example, when the temperature of the engine during the stationary phase exceeds a specified temperature.

During the stationary phase of the vehicle, the energy accumulator (battery) or accumulators supply the electric consuming devices (loads) of the vehicle as the only energy source. The energy accumulators are normally constructed as batteries with a 12 V nominal voltage level in lead acid technology.

By first approximation, the frequency of stationary phases, when the internal-combustion engine is automatically switched off, and the duration of stationary phases when the internal-combustion engine is automatically switched off, correlate with the energy withdrawn from the at least one energy accumulator during these stationary phases. Since the withdrawn energy, during the driving operation when the engine is started is at least partially charged back into the battery by a generator coupled to the engine (ideally by recuperation without fuel consumption), this results in an increased battery cyclization in relation to the total driving power of the vehicle. As a result, wear phenomena of the accumulator are increased or accelerated.

It is an object of the invention to provide an improved vehicle having an internal-combustion engine, which can be automatically switched off by way of an engine start-stop device and can be automatically started.

This and other objects are achieved by a vehicle according to the invention. The vehicle comprises at least one electric energy accumulator and at least one electric consuming device, in which case, when the internal-combustion engine is automatically switched off, a stop current strength can be determined which is withdrawn from the at least one electric energy accumulator by the at least one electric consuming device, and the engine start-stop device automatically starts the internal-combustion engine when a predefined stop current threshold or a predefined stop discharge threshold is exceeded.

When the engine is switched off, the electric power demanded by each electric consuming device (load) is provided exclusively by the at least one energy accumulator. The amount of the current withdrawn from the accumulator (preceding sign of this withdrawn current defined as positive) is called the “stop current strength”. A rising stop current strength leads to a faster lowering of the charge state of the energy accumulator. When the stop current strength exceeds a predefined limit value here called a “stop current threshold” the engine start-stop device will automatically start the engine. An electric machine mechanically coupled with the internal-combustion engine will then supply the electric consuming devices and relieve or charge the energy accumulator or accumulators.

According to a further embodiment of the invention, the vehicle includes a control unit, a data bus system and an engine start system. In the case of an automatically switched-off internal-combustion engine, the control unit compares a value of the stop current strength with the predefined stop current threshold and, in the case of an exceeding of the stop current threshold by the value of the stop current strength in the direction of a rising current strength, transmits an engine start prompt to the engine start system by way of the data bus system. When the engine start prompt is transmitted, the engine start system will start the internal-combustion engine.

For this purpose, as a function of the architecture of the control unit, one or more software functions are carried out in the control unit. In the following, this at least one software function will be called a power management function.

As an alternative, it is advantageous, when the vehicle includes a control unit, a data bus system and an engine start system, when the internal-combustion engine is automatically switched-off, for the control unit by integration of the stop current strength over time to determine a value of a stop discharge amount; for the control unit to compare the value of the stop discharge amount with the predefined stop discharge threshold; and, in the case of an exceeding of the stop discharge threshold by the value of the stop discharge amount in the direction of a rising stop discharge amount, for the control unit to transmit an engine start prompt to the engine start system by way of the data bus system, for the engine start system to start the internal-combustion engine when the engine start prompt is transmitted.

In this case, the stop current strength is used as the output value in order to determine, while the internal-combustion engine is automatically switched off, the stop discharge amount withdraw from the battery. This takes place as an integration of the stop current strength over time starting from the determination of the stop current strength. In this case, the value of the stop discharge amount is compared with a predefined stop discharge threshold. When the value of the stop discharge amount exceeds the predefined stop discharge threshold, an engine start prompt is created.

According to a further variant of the present invention, the vehicle includes a current measuring device which measures the stop current strength withdrawn from the electric accumulator, and transmits the measured value of the stop current strength by way of the data bus system to the control unit.

Such a sensor can be integrated in the positive terminal of the battery. The sensor measures the entire current withdrawn from the battery.

As an alternative, the at least one electric consuming device, when the internal-combustion engine is automatically switched off, determines a consuming device current strength consumed by the at least one electric consuming device and transmits the determined value of the consuming device current strength by way of the data bus system to the control unit.

Thus, the current consumed by each individual electric consuming device is detected and transmitted to the control unit.

In the case of only one electric consuming device, the control unit assigns the value of the transmitted consuming device current strength to the value of the stop current strength.

As an alternative, in the case of several electric consuming devices, the control unit assigns the sum of several consuming device currents strengths to the value of the stop current strength. Thereby, the entire current consumed by all consuming devices is determined which is withdrawn from at least one energy accumulator.

Preferably, efficiency losses between the at least one energy accumulator and the consuming devices while forming the sum of the consuming device current strengths are additionally taken into account by a weighting factor.

Other objects, advantages and novel features of the present f will become apparent from the following detailed description of one or more preferred embodiments when considered in conjunction with the accompanying drawing.

### BRIEF DESCRIPTION OF THE DRAWING

FIG. 1 is a very high level block diagram of a vehicle according to an embodiment.

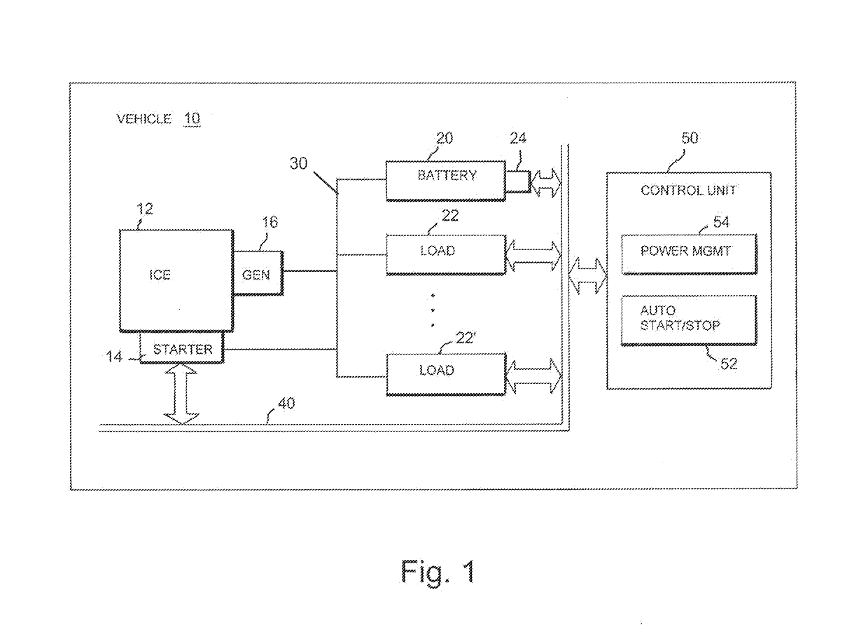

### DETAILED DESCRIPTION OF THE DRAWING

The invention is based on the considerations indicated in the following.

For reducing fuel consumption, modern vehicles are equipped with engine start-stop systems. When the engine is switched off, the electric onboard power supply system is supplied from the battery, which results in a discharge and an aging of the battery. Before the switching-off of the engine, the onboard power supply current can therefore be monitored by a power management function and, at high currents, the switching-off of the engine may be prevented.

This has the disadvantage that changes of the onboard power supply current, when the engine is switched off, may further result in high discharges and in a rapid aging of the accumulator.

In this context, it is provided that electric consuming devices report their respective current consumption to the power management function, so that, when a limit value is reached, a start of the engine can prompted.

It is also contemplated to measure the current in the onboard power supply system by use of the existing battery sensor and to prompt a switching-on of the engine on the basis of this measurement as a function of limit values.

This has the advantage that a high discharge and a rapid aging of the accumulator are thereby prevented.

A vehicle includes an internal-combustion engine, a starter for the internal-combustion engine and a generator mechanically coupled with the internal-combustion engine as the electric machine. The starter may be constructed as a pinion starter and the generator may be constructed as a clamp terminal generator. As an alternative, the starter and the generator may be integrated in a starter generator with a belt drive. The vehicle further has a 12V battery in lead acid technology and electric consuming devices. Examples of electric consuming devices are comfort-related consuming devices such as seat heaters, safety-relevant consuming devices such as window wipers, or technically required consuming devices such as engine fans. In addition, the vehicle has several control units, one control unit being constructed as an engine control unit.

The above-mentioned components are connected by way of a physical onboard power supply system for the exchange of electric power as well as by way of an onboard data system for the exchange of information. The physical onboard power supply network is implemented by way of cable trees and cable harnesses; the onboard data system is implemented, for example, by customary bus systems.

The vehicle has an automatic stop-and-start device for the engine, which is also called an engine start-stop function. In order to save fuel and reduce pollutant emissions, the engine of the vehicle is automatically switched off in operating phases in which the vehicle is stationary. A stop function in the engine control unit recognizes all conditions necessary for the switch-off (such as an extremely low vehicle speed or, in the case of a vehicle with a manual transmission, an engaged neutral gear) and transmits a switch-off prompt to the engine.

When the engine is switched off, the electric consuming devices of the vehicle are supplied with electric power from the battery. This reduces the charging state of the battery because current is withdrawn from e battery. Its amount is called the stop current strength.

This current can be determined directly by way of a battery sensor. This may be a Hall sensor that is mounted at the positive (+) line of the battery and is connected to the onboard data system of the vehicle. The sensor measures the current withdrawn from the battery at regular time intervals and transmits the time-dependent stop current strength to the engine control unit. A monitoring function in the control unit, which is called a power management function, compares the stop current strength when the engine is switched off with a specified limit value. When the stop current strength exceeds the specified limit value in the direction of an increasing stop current strength for a specified time period, the control unit will transmit an engine switch-on prompt to the starter of the engine and to the engine in order to start the engine. The predefined time period is considerably longer than the time interval between two current measurements of the battery sensor.

A second embodiment differs from the first embodiment in that no battery sensor is used, but the current consumed by each individual consuming device is determined This current is called a consuming device current strength. For this purpose, either a separate current sensor integrated in the onboard data system can in each case, be assigned to a feed line of the physical onboard power supply system of the respective consuming device; or, as an alternative, the consumed current can be measured by the respective consuming device, which is integrated in the onboard data system, by use of an integrated current sensor. A power consumption model of the respective consuming device may also be stored in a control unit, which determines the current. The respective consuming device or the respective separate current sensor, which determine the respective consuming device current strength at regular intervals, transmit the time-dependent consuming device current strength to the engine control unit.

As an alternative, it may be advantageous for the consuming device current strength to be determined implicitly. This may possibly be the case when a consuming device is operated in a predefined power stage, and the voltage applied as a function of time to the consuming device can be determined, for example, by use of a voltage divider. The time-dependent consuming device current strength can then be determined from these parameters according to the interrelationship between the power, the voltage and the current in a manner known to a person skilled in the art. Either these parameters are transmitted to the engine control unit and the engine control unit computes the consuming device current strength therefrom, or the consuming device current strength is computed by a control unit of the respective consuming device and is transmitted to the engine control unit.

In the case of several consuming devices, the respective consuming device current strengths can be determined in a respectively different manner. The respective technical effect in the case of each of these several consuming devices is that a consuming device current strength that can be assigned to the consuming device is transmitted to the engine control unit or can be computed by the engine control unit from transmitted parameters.

The power management function computes the sum of the determined consuming device current strengths and defines this time-dependent sum as the stop current strength. For the summation, the respectively most recent determined consuming device current strength is used for each consuming device.

The power management function compares the stop current strength with the specified limit value. If the stop current strength exceeds the specified stop current threshold in the direction of an increasing stop current strength for a specified time period, the control unit will transmit an engine switch-on prompt to the starter of the engine and to the engine in order to start the engine.

In order to take into account power losses between the energy accumulator the respective consuming device, which lead to a current of a higher amount that is withdrawn from the battery than is consumed in total by the consuming devices, the consuming device current strength can be additionally multiplied by a weighting factor>1 suitable for these power losses.

In an alternative embodiment, the value assigned to the current strength is integrated by way of the time duration of the automatically switched-off engine, and a value of a stop discharge amount is thereby determined. This value of the stop discharge amount is compared with a specified stop discharge threshold. When the value of the stop discharge amount exceeds the stop discharge threshold, an engine start prompt will occur.

The comparison with the stop discharge amount with the stop discharge threshold can also take place in addition to the comparison of the stop current strength with the stop current threshold. In this case, an engine start prompt will then take place when the value of the stop discharge amount exceeds the stop discharge threshold and/or the value of the stop current strength exceeds the stop current threshold.

All embodiments have a significant advantage in common in that the battery can be protected from high cyclization. For this purpose the stop current threshold and/or the stop discharge threshold can be defined in a suitable manner. In this case, the stop current threshold depends on the given quality and from the given design of the energy accumulators being used as well as on the anticipated service life of the energy accumulators.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A vehicle, comprising:
an internal-combustion engine;
an engine start-stop device configured to automatically switch off and automatically start the internal-combustion engine;
at least one electric energy accumulator;
at least one electric consuming device, wherein
when the internal-combustion is automatically switched-off, a stop current strength withdrawn from the electric energy accumulator by the electric consuming device is determined, and
when the stop current strength exceeds a predefined stop current threshold or a predefined stop discharge threshold, the engine start-stop device automatically starts the internal-combustion engine.

2. The vehicle according to claim 1, further comprising:
a control unit and a data bus system, wherein the control unit is operatively configured to:
when the internal-combustion is switched-off, compare a value of the stop current strength with the predefined stop current threshold,
when the value of the stop current strength exceeds the predefined stop current threshold in a direction of a rising current strength, transmits an engine start prompt to the engine start-stop device via the data bus system, whereby the engine start-stop device starts the internal-combustion engine based on the transmitted engine start prompt.

3. The vehicle according to claim 1, further comprising:
a control and a data bus system, wherein the control unit is configured to:
when the internal-combustion engine is automatically switched-off, determine a stop discharge amount by integrating the stop current strength over time,
compare a value of the stop discharge amount with the predefined stop discharge threshold, and
when the value of the stop discharge amount exceeds the stop discharge threshold in a direction of a rising stop discharge amount, transmits an engine start prompt via the data bus system, whereby the engine start-stop device starts the internal-combustion engine based on the transmitted engine start prompt.

4. The vehicle according to claim 2, further comprising:
a current measuring device configured to measure the stop current strength withdrawn from the electric energy accumulator, wherein
the current measuring device transmits tire measured value of the stop current strength via the data bus system to the control unit.

5. The vehicle according to claim 3, further comprising:
a current measuring device configured to measure the stop current strength withdrawn from the electric energy accumulator, wherein
the current measuring device transmits the measured value of the stop current strength via the data bus system to the control unit.

6. The vehicle according to claim 2, wherein the electric consuming device, when the internal-combustion engine is automatically switched-off, is configured to determine a consuming device current strength consumed by the electric consuming device, and
wherein the electric consuming device transmits the determined consuming device current strength via the data bus system to the control unit.

7. The vehicle according to claim 3, wherein the electric consuming device, when the internal-combustion engine is automatically switched-off, is configured to determine a consuming device current strength consumed by the electric consuming device, and
wherein the electric consuming device the determined consuming device current strength via the data bus system to the control unit.

8. The vehicle according to claim 6, wherein, in the case of an electric consuming device, the control unit assigns a value of the consuming device current strength to the value of the stop current strength.

9. The vehicle according to claim 1, wherein, in the case of an electric consuming device, the control unit assigns a value of the consuming device current strength to the value of the stop current strength.

10. The vehicle according to claim 6, wherein in the case of several electric consuming devices, the control unit assigns a sum of several consuming device current strengths to a value of the stop current strength.

11. The vehicle according to claim 7, wherein in the case of several electric consuming devices, the control unit assigns a sum of several consuming device current strengths to a value of the stop current strength.

12. A method of operating a vehicle having an internal-combustion engine and an engine start-stop device by which the internal-combustion engine is automatically switched-off and automatically started, the method comprising the acts of:
determining a stop current strength withdrawn from an electric energy accumulator of the vehicle by an electric consuming device of the vehicle when the internal-combustion engine is automatically switched-off; and
automatically starting the internal-combustion engine, by the engine start-stop device, when a predefined stop current threshold or a predefined stop discharge threshold is exceeded.
